(19) United States
(12) Patent Application Publication
(10) Pub. No.: US 2023/0049089 A1
(43) Pub. Date: Feb. 16, 2023

(54) Method and Apparatus For Predicting Power Consumption, Device and Readiable Storage Medium

(71) Applicants: ENVISION DIGITAL INTERNATIONAL PTE. LTD., Singapore (SG); SHANGHAI ENVISION DIGITAL CO., LTD., Shanghai (CN)

(72) Inventor: Qi CHENG, Pilot Free Trade Zone, Shanghai (CN)

(21) Appl. No.: 17/789,988

(22) PCT Filed: Dec. 23, 2020
(86) PCT No.: PCT/SG2020/050773

§ 371 Date: Jun. 29, 2022

(30) Foreign Application Priority Data
Dec. 31, 2019 (CN) 201911405459.9

(51) Int. Cl. G05B 19/042; G06Q 50/06; G06Q 10/04

(52) U.S. Cl. CPC G05B 19/042; G06Q 50/06; G06Q 10/04; G05B 2219/2639

(57) ABSTRACT

A method and apparatus for predicting power consumption, a device, and a readable storage medium. The method includes: acquiring a reference variable generated in a history time period; and acquiring predicted power consumption in a target time period by inputting a variable characteristic into a power consumption prediction model, the target time period and the history time period having a corresponding relationship, and the power consumption prediction model being obtained by training a sample reference variable marked with sample power consumption. In the method, the reference variable including a discrete reference variable and a continuous reference variable in the history time period is acquired, and a characteristic of the acquired reference variable is acquired; and an extracted variable characteristic is input into a variable prediction model to output the predicted power consumption in the target time period.

### TECHNICAL FIELD

The present disclosure relates to the field of power consumption prediction, and in particular to a method and apparatus for predicting power consumption, a device and a readable storage medium.

### BACKGROUND

With the development of society, more and more attention is being paid to the use of electric energy by users, and prediction of power consumption is an important method for evaluating the use of electric energy by users.

In the related art, user's power consumption is generally estimated based on experience, that is, the user's history power consumption is segmented according to time, and the power consumption in a future target time period is predicted based on an absolute value and a change trend of the history power consumption in each time period. In an example where a user predicts power consumption in the first quarter of the next year based on the power consumption in the current year, the user segments the power consumption in the current year into power consumption of four quarters of the current year, and predicts the power consumption in the first quarter of the next year based on the absolute value and the change trend of the power consumption of the four quarters in the current year.

However, in the estimation methods in the related art, the future power consumption is estimated only by the power consumption and the segmented power consumption of the current year. Due to few parameters for estimation, prediction of the future power consumption is inaccurate.

### SUMMARY

The present disclosure relates to a method and apparatus for predicting power consumption, a device and a readable storage medium. During the prediction of power consumption, the power consumption in a target time period is predicted from different perspectives based on various parameters, so that the accuracy in predicting the power consumption is improved. The technical solutions are as follows.

In an aspect, a method for predicting power consumption is provided. The method includes:

acquiring a reference variable generated by an electric device in a history time period, the reference variable including a discrete reference variable and a continuous reference variable, the discrete reference variable being collected according to a preset duration in the history time period, and the continuous reference variable being continuously collected in the history time period;

acquiring a variable characteristic by extracting a characteristic of the reference variable with a power consumption prediction model, wherein the power consumption prediction model is obtained by training a sample reference variable marked with sample power consumption, the sample reference variable including a sample discrete variable and a sample continuous variable; and

acquiring predicted power consumption in a target time period by prediction with the power consumption prediction model based on the variable characteristic, the target time period and the history time period having a corresponding relationship.

In an optional embodiment, acquiring the variable characteristic by extracting the characteristic of the reference variable includes:

acquiring a discrete variable characteristic by extracting a characteristic of the discrete reference variable with the power consumption prediction model;

acquiring a continuous variable characteristic by extracting a characteristic of the continuous reference variable with the power consumption prediction model; and

acquiring the variable characteristic by referring to the discrete variable characteristic with the continuous variable characteristic.

In an optional embodiment, acquiring the discrete variable characteristic by extracting the characteristic of the discrete reference variable with the power consumption prediction model includes:

acquiring a normalized discrete variable by performing data normalization on the discrete reference variable within a first preset data range with the power consumption prediction model;

building a discrete characteristic matrix corresponding to the normalized discrete variable; and

acquiring the discrete variable characteristic corresponding to the discrete reference variable by calculating with reference to the discrete characteristic matrix.

In an optional embodiment, acquiring the normalized discrete variable by performing the data normalization on the discrete reference variable within the first preset data range with the power consumption prediction model includes:

acquiring the normalized discrete variable by mapping the discrete reference variable to the first preset data range with the power consumption prediction model.

In an optional embodiment, the discrete reference variable includes at least one of a time reference variable, a season reference variable and a holiday reference variable;

the time reference variable includes a date corresponding to the history time period;

the season reference variable includes a season corresponding the history time period; and

the holiday reference variable includes nature of a holiday corresponding to the history time period.

In an optional embodiment, acquiring the continuous variable characteristic by extracting the characteristic of the continuous reference variable with the power consumption prediction model includes:

acquiring a normalized continuous variable by performing data normalization on the continuous reference variable in a second preset data range with the power consumption prediction model;

building a continuous characteristic matrix based on the normalized continuous variable; and

acquiring the continuous variable characteristic corresponding to the continuous reference variable by calculating the continuous characteristic matrix.

In an optional embodiment, acquiring the normalized continuous variable by performing the data normalization on the continuous reference variable in the second preset data range with the power consumption prediction model includes:

acquiring the normalized continuous variable by mapping the continuous reference variable to the second preset data range with the power consumption prediction model.

In an optional embodiment, the continuous reference variable includes at least one of a temperature reference variable, a power consumption reference variable and a humidity reference variable;

the temperature reference variable indicates temperature in the history time period;

the power consumption reference variable indicates total power consumption in the history time period; and

the humidity reference variable indicates air humidity in the history time period.

In another aspect, an apparatus for predicting power consumption is provided. The apparatus includes:

an acquiring module, configured to acquire a reference variable generated in a history time period, the reference variable including a discrete reference variable and a continuous reference variable, the discrete reference variable being collected according to a preset duration in the history time period, and the continuous reference variable being continuously collected in the history time period;

an extracting module, configured to acquire a variable characteristic by extracting a characteristic of the reference variable with a power consumption prediction model; and

a predicting module, configured to acquire predicted power consumption in a target time period by prediction with the power consumption prediction model based on the variable characteristic, the target time period and the history time period having a corresponding relationship.

In an optional embodiment, the extracting module is configured to acquire a discrete variable characteristic by extracting a characteristic of the discrete reference variable with the power consumption prediction model; and

the extracting module is further configured to acquire a continuous variable characteristic by extracting a characteristic of the continuous reference variable with the power consumption prediction model.

The apparatus further includes a referring module, configured to acquire the variable characteristic by referring to the discrete variable characteristic with the continuous variable characteristic.

In an optional embodiment, the apparatus further includes a processing module, configured to acquire a normalized discrete variable by performing data normalization on the discrete reference variable within a first preset data range with the power consumption prediction model, the first preset data range indicating a data range for performing data normalization on the discrete reference variable;

a building module, configured to build a discrete characteristic matrix based on the normalized discrete variable; and

a calculating module, configured to acquire a discrete variable characteristic corresponding to the discrete reference variable by calculating the discrete characteristic matrix.

In an optional embodiment, the apparatus further includes a mapping module, configured to acquiring the normalized discrete variable by mapping the discrete reference variable to the first preset data range with the power consumption prediction model.

In an optional embodiment, the discrete reference variable includes at least one of a time reference variable, a season reference variable and a holiday reference variable;

the time reference variable includes a date corresponding to the history time period;

the season reference variable includes a season corresponding the history time period; and

the holiday reference variable includes nature of a holiday corresponding to the history time period.

In an optional embodiment, the apparatus further includes a processing module, configured to acquire a normalized continuous variable by performing data normalization on the continuous reference variable in a second preset data range with the power consumption prediction model;

the building module is configured to build a continuous characteristic matrix according to the normalized continuous variable; and

the calculating module is configured to acquire a continuous variable characteristic corresponding to the continuous reference variable by calculating the continuous characteristic matrix.

In an optional embodiment, the mapping module is configured to obtain the normalized continuous variable by mapping the continuous reference variable to the second preset data range with the power consumption prediction model.

In an optional embodiment, the continuous reference variable includes at least one of a temperature reference variable, a power consumption reference variable, and a humidity reference variable;

the temperature reference variable indicates temperature in the history time period;

the power consumption reference variable indicates total power consumption in the history time period;

the humidity reference variable indicates air humidity in the history time period.

In yet another aspect, a computer device is provided. The computer device includes a processor and a memory storing at least one instruction, at least one program, at least one code set or instruction set therein. The at least one instruction, the at least one program, the at least one code set or instruction set, when loaded and executed by the processor, causes the processor to implement the method for predicting power consumption in accordance with the aforementioned embodiment of the present disclosure.

In still another aspect, a computer-readable storage medium is provided. The computer-readable storage medium stores at least one instruction, at least one program, at least one code set or instruction set therein. The at least one instruction, the at least one program, the at least one code set or instruction set, when loaded and executed by a processor, causes the processor to implement the method for predicting power consumption in accordance with the aforementioned embodiment of the present disclosure.

In still yet another aspect, a computer program product is provided. The computer program product, when running on a computer, enables the computer to implement the method for predicting power consumption in accordance with any one of the embodiments of the present disclosure.

The technical solutions provided by the present disclosure have at least the following beneficial effects.

By acquiring the reference variable including the discrete reference variable and the continuous reference variable in the history time period, extracting the characteristic of the reference variable, and inputting the extracted variable characteristic into the variable prediction model to output the predicted power consumption in the target time period, during prediction of power consumption, the power consumption in the target time period is predicted from different perspectives based on various parameters, so that the accuracy in predicting the power consumption is improved.

### BRIEF DESCRIPTION OF THE DRAWINGS

To describe the technical solutions in the embodiments of the present disclosure more clearly, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a structural schematic diagram of a Gated Recurrent Unit (GRU) in the related art;

FIG. 2 is a flow chart of a method for predicting power consumption in accordance with an example embodiment of the present disclosure;

FIG. 3 is a flow chart of acquiring a discrete variable characteristic by extracting a discrete reference variable in accordance with an example embodiment of the present disclosure;

FIG. 4 is a schematic diagram of a method for building a discrete characteristic matrix based on a discrete reference variable in accordance with an example embodiment of the present disclosure;

FIG. 5 is a flow chart of acquiring a continuous variable characteristic by extracting a continuous reference variable in accordance with an example embodiment of the present disclosure;

FIG. 6 is a schematic diagram of acquiring a continuous variable characteristic by convolution kernel calculation in accordance with an example embodiment of the present disclosure;

FIG. 7 is a schematic diagram showing training of a convolution kernel in accordance with an example embodiment of the present disclosure;

FIG. 8 is flow chart of a method for predicting power consumption in accordance with an example embodiment of the present disclosure;

FIG. 9 is a schematic diagram of acquiring predicted power consumption in a target time period by inputting a variable characteristic into a power consumption prediction model in accordance with an example embodiment of the present disclosure;

FIG. 10 is a structural block diagram of an apparatus for predicting power consumption in accordance with an example embodiment of the present disclosure; and

FIG. 11 is a structural diagram of a server in accordance with an example embodiment of the present disclosure.

### DETAILED DESCRIPTION

The embodiments of the present disclosure will be described in further detail with reference to the accompanying drawings, to present the objectives, technical solutions, and advantages of the present disclosure more clearly.

First, terms involved in the embodiments of the present disclosure are introduced briefly.

Artificial Intelligence (AI) is a technology of presenting human intelligence by computer programs, and furthermore, it may also represent learning of people's intelligent behaviors by machines. AI is a branch of computer science and is intended to study design principles and implementation methods of various intelligent machines, so that the machines have the functions of perception, reasoning and decision-making. AI technology is a comprehensive subject, which covers a wide range of fields, including both hardware-level technologies and software-level technologies. AI software technologies mainly include computer vision technology, speech processing technology, natural language processing technology, and machine learning/deep learning, and the present embodiment mainly involves machine learning technology.

Machine Learning (ML) is a multi-field interdisciplinary subject, which involves probability theory, statistics, approximation theory, convex analysis, algorithm complexity theory and other subjects, and is mainly used for studying how a computer simulates or implements human learning behaviors to acquire new knowledge or skills, and to reorganize the existing knowledge structure to continuously improve its own performance. Machine learning and deep learning usually include artificial neural networks, belief networks, reinforcement learning, transfer learning, inductive learning, teaching learning and other technologies, and the present embodiment mainly involves artificial neural network technology.

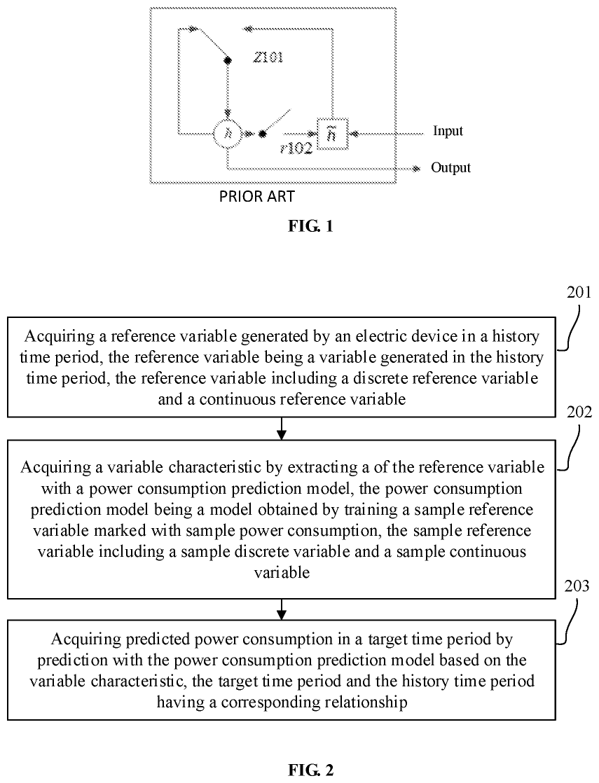

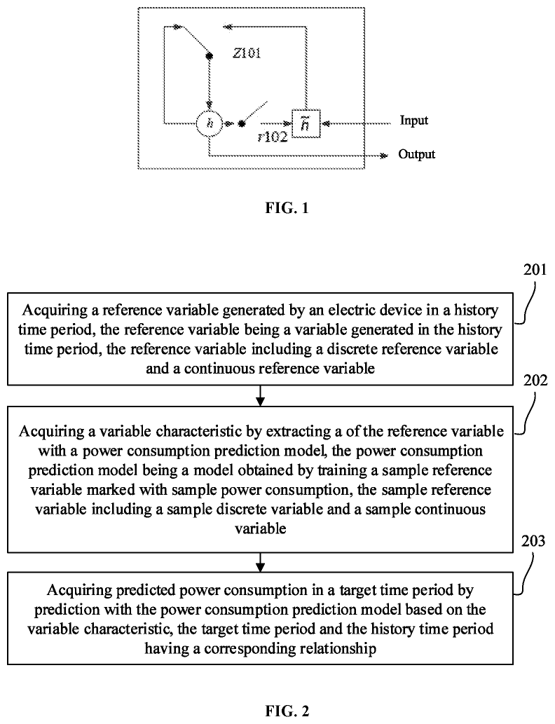

Gated Recurrent Unit (GRU) is a variant of Long Short-Term Memory (LSTM). The structure of GRU is very similar to that of LSTM. LSTM has three gates while GRU has only two gates and no cellular status, thereby simplifying the structure of LSTM. FIG. 1 is a structural schematic diagram of a GRU in the related art. Referring to FIG. 1, the two gates of the GRU are an update gate z101 and a reset gate r102. The “update gate” serves the function of controlling how much information number of the unit status at the previous moment can be brought to the current status, and the “reset gate” serves the function of controlling information number that can be written into the current status from the previous status.

With the development of society, more and more attention is being paid to the use of electric energy by users, and prediction of power consumption is an important method for evaluating the use of electric energy by users.

However, in the estimation methods of the related art, there are few parameters for estimation, and even only the total power consumption is taken as a parameter for estimation. Therefore, prediction of the future power consumption is inaccurate.

FIG. 2 is a flow chart of a method for predicting power consumption in accordance with an example embodiment of the present disclosure. By taking that the method is applied to a server as an example for explanation, the method includes the following steps.

In step 201, a reference variable generated by an electric device in a history time period is acquired. The reference variable is a variable generated in the history time period, and the reference variable includes a discrete reference variable and a continuous reference variable.

Optionally, the electric device is a device that works with electric energy in the history time period, and records its own power consumption by other devices.

Optionally, the server that predicts power consumption stores the power consumption in the history time period and the reference variable generated in the history time period. Optionally, the power consumption in the history time period indicates the total power consumption of a user in the history time period, received by the server. Optionally, the server may receive a plurality of reference variables in the history time period, and the plurality of reference variables all are variables generated in the history time period. In an example, the user records the power consumption in one time period, and records the ambient temperature and the date of electricity utilization at the same time by using an intelligent electric meter, and sends recorded data to the server, such that the server stores these data. Optionally, these data is stored in the server in a whole-period storing manner while being updated in real time.

When the user needs to extract the information during a history time period, the server intercepts the data in this time period as the power consumption in the history time period and the reference variable generated in the history time period.

Optionally, the reference variable includes a discrete reference variable.

Optionally, the discrete reference variable is a reference variable collected according to a preset duration in the history time period. Optionally, one preset duration is a period during which one discrete reference variable is recorded. In an example, if the preset duration is one day and the discrete reference variable is a date, the discrete reference variable is recorded only once in one preset duration, i.e., within one day. For example, the date recorded is the 10^{th} day of the current month, and the discrete reference variable is recorded for the second time one day later, i.e., the date is the 11^{th} natural day of the month.

Optionally, the reference variable includes a continuous reference variable.

Optionally, the continuous reference variable is a variable continuously collected in the history time period. Optionally, the continuous reference variable changes in real time, and thus needs to be recorded in real time. In an example, the continuous reference variable is the temperature around the meter used for recording power consumption. Since temperature is a variable that changes in real time, it is necessary to record changes of the temperature in real time. Optionally, after the user's ambient temperature is collected, a change curve of the ambient temperature is generated and sent to the server.

In step 202, the characteristic of the reference variable is extracted with a power consumption prediction model to acquire a variable characteristic. The power consumption prediction model is obtained by training a sample reference variable marked with sample power consumption, and the sample reference variable includes a sample discrete variable and a sample continuous variable.

Optionally, the characteristic value corresponding to one reference variable is derived from a plurality of characteristic dimensions, that is, one reference variable has different characteristic values in different characteristic dimensions.

Optionally, the process of extracting the characteristic of the reference variable is implemented in the power consumption prediction model, which is configured to acquire predicted power consumption.

Optionally, after the characteristic values in plurality of characteristic dimensions of one reference variable are acquired, a characteristic matrix can be built based on the characteristic values in the plurality of dimensions, and the variable characteristic corresponding to the reference variable is acquired by processing the characteristic matrix. In an example, the reference variable is a continuous reference variable, and the reference variable is the temperature around the electric meter used for recording the power consumption. When the characteristic of the reference variable is extracted, the characteristic values of the variable in a plurality of dimensions preset by the server are extracted first. In this embodiment, the server extracts the characteristic values in a total of 20 different dimensions, and the characteristic value in each dimension is embodied in the form of a numerical value. A 1-row 20-column characteristic matrix is built based on the characteristic values in the 20 different dimensions, and the characteristic matrix is a characteristic matrix of the corresponding reference variable that is the temperature around the electric meter used for recording the power consumption. By processing this characteristic matrix, the variable characteristic of the temperature around the electric meter used for recording the power consumption may be finally acquired. In this embodiment, processing of the characteristic matrix is to multiply the characteristic matrix with a 20-row 1-column matrix preset in the server to finally acquire one numerical value, and the numerical value is the variable characteristic corresponding to the reference variable, that is, the temperature around the electric meter used for recording the power consumption.

Optionally, after acquiring the continuous variable characteristic and the discrete variable characteristic, the power consumption prediction model performs weighting summation calculation on them to acquire the variable characteristics. Optionally, weights of the continuous variable characteristic and the discrete variable characteristic are acquired by training the power consumption prediction model.

In step 203, predicted power consumption in a target time period prediction is acquired by prediction with the power consumption prediction model based on the variable characteristic, and the target time period and the history time period have a corresponding relationship.

Optionally, as described in step 202, the power consumption prediction model is configured to acquire the predicted power consumption. Optionally, there are variable characteristics of a plurality of parameter variables in one target time period, and numerical values of the variable characteristics are worked out by means of weighted summation. Optionally, acquisition of variable characteristics by variable characteristics may also be completed in the power consumption prediction model, that is, a plurality of variable characteristics corresponding to one history time period are input into the power consumption prediction model, and weighted summation is performed on these variable characteristics in the power consumption prediction model to acquire the variable characteristics.

Optionally, the weights of the continuous variable characteristic and the discrete variable characteristic described in the above steps are acquired by training. The training method includes: acquiring a training result according to a minimized loss function, and correcting the weights corresponding to the continuous variable characteristic and the discrete variable characteristic by a neural network back propagation calculation method with reference to the training result. In one example, the minimized loss function is as shown in Formula 1:

$$\sqrt{\frac{1}{m} {\sum }_{i = 1}^{m} {( {y}_{i} - \hat{{y}_{i}} )}^{2}} , \qquad Formula 1$$

in which

m is the total number of times of training, i is the serial number of the time of training, [symbol] is sample predicted power consumption output in the training, and [symbol] is the real history power consumption in the training. After training the power consumption prediction model according to the minimized loss function by the neural network back propagation calculation method, the weights corresponding to the discrete variable characteristics and continuous variable characteristics can be gradually determined, and the variable characteristic corresponding to the history time period is acquired finally based on the weights with reference to the discrete variable characteristic and the continuous variable characteristic.

Optionally, the target time period is a time period in the future, that is, a estimated time period during which the power consumption needs to be predicted. Optionally, there is a corresponding relationship between the target time period and the history time period. Optionally, the target time period and the history time period have the same time length. In an example, the target time period and the history time period are both time periods with a time length of 24 hours. Optionally, the target time period and the history time period are in the same phase of different time cycles. In an example, the time cycle is one week, the target time period is the third day of the second week, and the history time period is the third day of the first week. The history time period and the target time period are in two different time cycles, that is, the history time period and the target time period are in two different weeks, but the history time period and the target time period are in the same time period of different time cycles. In this example, the target time period is Wednesday of the second week, and the history time period is Wednesday of the first week. When the server needs to predict the power consumption during the target time period, it acquires the reference variable of the history time period.

Optionally, the power consumption prediction model is a cyclic memory neural network model that encodes and decodes the characteristic values after multiple GRUs are connected. Optionally, one variable characteristic is input into one GRU, or all variable characteristics corresponding to one history time period are input into one GRU, that is, the variable characteristic input into each GRU corresponds to one history time range. Optionally, the power consumption prediction model can output the predicted power consumption in at least one target time period based on at least one variable characteristic. Optionally, the number of the target time periods is at least one.

Optionally, predicted power consumption in a subsequent target time period may be predicted based on the predicted power consumption in one target time period. In an example, there are three target time periods. The predicted power consumption corresponding to the first target time period, after being acquired, is input into the power consumption prediction model to acquire predicted power consumption corresponding to the second target time period, and the predicted power consumption corresponding to the second target time period is input into the power consumption prediction model to acquire predicted power consumption corresponding to the third target time period. Optionally, when there are a plurality of target time periods, the order of predicting power consumption in the target time periods is that the power consumption corresponding to the earlier target time period is predicted first, and the predicted power consumption corresponding to the earlier target time period is re-input into the power consumption prediction model to acquire predicted power consumption corresponding to the later target time period.

Optionally, the power consumption prediction model is a machine learning model, and performs supervised training by the sample reference variable marked with the sample power consumption. Optionally, the sample reference variable includes a sample discrete variable and a sample continuous variable. Both the sample reference variable and the sample continuous variable have sample variable characteristics. The power consumption prediction model is trained by inputting the sample variable characteristic into the power consumption prediction model. Optionally, the sample reference variable may also be acquired from a simulation value to perform preliminary training on the power consumption prediction model. After the preliminary training, further training is performed based on the real history power consumption in the history time period.

Optionally, the history time period stored in the server is selected as the sample target time period, its corresponding power consumption is taken as the real history power consumption, and the sample history time period and the sample reference variable corresponding to the sample target time period are acquired. Optionally, the sample reference variable is input into the power consumption prediction model, the acquired sample predicted power consumption is compared with the real history power consumption, and the power consumption prediction model is trained based on the comparison result. Optionally, by substituting the real history power consumption and the sample predicted power consumption into a loss function, parameters in the power consumption prediction model are adjusted so that the value of the sample predicted power consumption is as close as possible to the value of the real history power consumption to complete training of the power consumption prediction model.

Optionally, the sample predicted power consumption in the sample target time period which is predicted by the sample reference variable is actually the power consumption in the history time period stored in the server. Optionally, the power consumption of the history time period corresponding to the sample target time period is selected as a comparison value of the sample reference variable for training, and the power consumption prediction model is trained by comparing the comparison value with the sample predicted power consumption.

In summary, according to the method provided by the present embodiment, by acquiring the reference variable including the discrete reference variable and the continuous reference variable in the history time period, extracting the characteristic of the reference variable, and inputting the extracted variable characteristic into the variable prediction model to output the predicted power consumption in the target time period, during prediction of power consumption, the power consumption in the target time period is predicted from different perspectives based on various parameters, so that the accuracy in predicting the power consumption is improved.

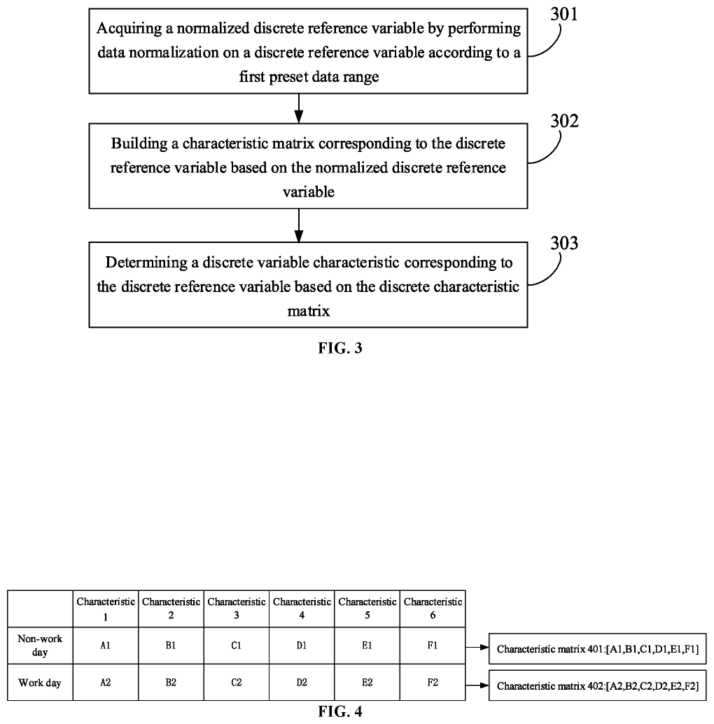

FIG. 3 is a flow chart of acquiring a discrete variable characteristic by extracting a discrete reference variable in accordance with an example embodiment of the present disclosure. By taking that the method is applied to a server as an example for explanation, the method includes the following steps.

In step 301, a normalized discrete reference variable is acquired by performing data normalization on a discrete reference variable according to a first preset data range.

Optionally, the method for extracting a discrete variable characteristic described in the present embodiment is completed in the power consumption prediction model as described in step 202.

As described in step 201, the discrete reference variable is collected according to the preset duration in the history time period.

Optionally, the discrete reference variable includes at least one of a time reference variable, a season reference variable, and a holiday reference variable. The time reference variable includes a date corresponding to the history time period; the season reference variable includes a season corresponding to the history time period; and the holiday reference variable includes nature of a holiday corresponding to the history time period. Optionally, when the server acquires the reference variable, a plurality of discrete time variables corresponding to the history time period may be acquired at a time. In an example, the history time period is from midnight to twenty-four o'clock in a day, and when acquiring the reference variable, the server may acquire the date corresponding to the history time period, the season corresponding to the history time period, and whether the history time period is a holiday.

In an example, the discrete reference variable is a holiday reference variable, which is generated by the nature of the holiday corresponding to the history time period, and the holiday reference variable includes a non-work day reference variable and a work day reference variable. In this case, each of the non-work day reference variable and the work day reference variable needs to have a corresponding characteristic value in at least one dimension.

Optionally, due to a big value difference of the reference variables, the characteristic values in at least one dimension extracted from the discrete reference variable also have a big value difference, which causes inconvenience to building of the characteristic matrix and subsequent calculation, so data normalization is performed on the discrete reference variable according to the first preset data range to acquire the normalized discrete reference variable. Optionally, the first preset data range is a data range for performing data normalization on the discrete reference variable, and the normalized discrete reference variable is mapping of the discrete reference variable in the first preset data range. In an example, the discrete reference variable is a date reference variable, and then a data value corresponding to the date reference variable should be 1 to 31 according to the arrangement of natural days, and data normalization can be performed on the original data value of 1 to 31 by setting the first preset data range to be 0 to 1. Optionally, after the data normalization, the characteristic value in each dimension of the processed normalized discrete reference variable is also a normalized characteristic value.

In step 302, a characteristic matrix corresponding to the discrete reference variable is built based on the normalized discrete reference variable.

Optionally, a discrete characteristic matrix corresponding to each variable type in each discrete reference variable is built.

Optionally, building the discrete characteristic matrix corresponding to the discrete reference variable based on the normalized discrete reference variable includes building of the discrete characteristic matrix based on normalized characteristic values in all dimensions, or building of the discrete characteristic matrix based on normalized characteristic values in some dimensions.

In an example, the discrete reference variable is a holiday reference variable, that is, a discrete reference variable generated by the nature of the holiday corresponding to the history time period, and the holiday reference variable includes a non-work day reference variable and a work day reference variable. In this case, each of the non-work day reference variable and the work day reference variable needs to have a corresponding characteristic value in at least one dimension. The value of the non-work day reference variable is set to 0 and the value of the work day reference variable is set to 1 according to the first preset data range of 0 to 1, and discrete characteristic matrices are built respectively based on the 6-dimensional characteristics. FIG. 4 is a schematic diagram of a method for building a discrete characteristic matrix in accordance with an example embodiment of the present disclosure. Referring to FIG. 4, the discrete reference variable includes a non-work day reference variable and a work day reference variable, each of which has 6-dimensional characteristics. The 6-dimensional characteristics of the non-work day reference variable are A1, B1, C1, D1, E1, F1, and the 6-dimensional characteristics of the work day reference variable are A2, B2, C2, D2, E2, F2. The generated characteristic matrix corresponding to the non-work day reference variable is a 1-row 6-column characteristic matrix 401: [A1,B1,C1,D1,E1,F1], and the generated characteristic matrix corresponding to the work day reference variable is a 1-row 6-column characteristic matrix 402: [A2, B2, C2, D2, E2, F2].

In step 303, a discrete variable characteristic corresponding to the discrete reference variable is determined based on the discrete characteristic matrix.

In the foregoing embodiment, each of the discrete characteristic matrix 401 and the discrete characteristic matrix 402 has 6 normalized characteristic values. Optionally, the corresponding discrete variable characteristic is acquired by calculating the discrete characteristic matrix.

In an optional embodiment, the discrete variable characteristic is acquired by cross-multiplying a characteristic acquiring matrix with the discrete characteristic matrix. Optionally, the characteristic acquiring matrix may be preset by the server, or adjusted in real time based on the discrete characteristic variable. Optionally, all the discrete characteristic matrices acquire the discrete variable characteristics corresponding thereto by the same characteristic acquiring matrix. Optionally, the discrete characteristic matrices corresponding to different characteristic acquiring matrices are different from each other, and the discrete variable characteristics finally acquired are different.

In summary, according to the method provided by the present embodiment, by normalizing the discrete reference variable, building the discrete characteristic matrix, processing the discrete characteristic matrix by the characteristic acquiring matrix to finally acquire the discrete variable characteristic, the characteristic matrix is independently generated for each result of each discrete reference variable and processed to obtain the corresponding discrete variable characteristic, and the processed discrete variable characteristic is input into the power consumption prediction model. Thus, the accuracy in predicting the power consumption is improved.

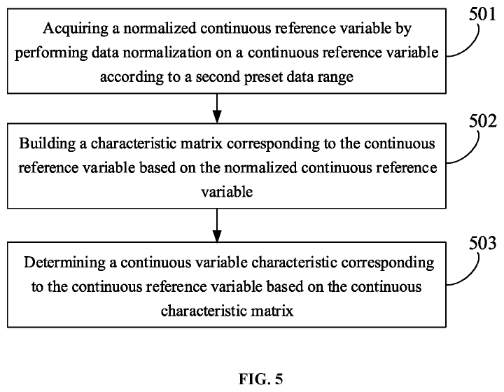

FIG. 5 a flow chart of obtaining a continuous variable characteristic by extracting a continuous reference variable in accordance with an example embodiment of the present disclosure. By taking that the method is applied to a server as an example for explanation, the method includes the following steps.

In step 501, a normalized continuous reference variable is obtained by performing data normalization on a continuous reference variable according to a second preset data range.

Optionally, a method for extracting a continuous variable characteristic described in the present embodiment is completed in the power consumption prediction model as described in step 202.

As described in step 201, the continuous reference variable is continuously collected by a continuous variable in a history time period.

Optionally, the continuous reference variable includes at least one of a temperature reference variable, a power consumption reference variable, and a humidity reference variable. The temperature reference variable is used for indicating a temperature in the history time period. The power consumption reference variable is used for indicating total power consumption in the history time period. The humidity reference variable is used for indicating air humidity in the history time period.

In an example, the continuous reference variable is a power consumption reference variable, i.e., total power consumption corresponding to the history time period. Optionally, the server calls cumulative total power consumption in the corresponding history time period, and subtracts the cumulative total power consumption at the beginning of the history time period from the cumulative total power consumption at the end of the history time period to acquire the power consumption reference variable in the history time period.

Optionally, data normalization is performed on the continuous reference variable according to a second preset data range to obtain a normalized continuous reference variable. Optionally, the second preset data range is a data range for performing data normalization on the continuous reference variable, and the normalized continuous reference variable is mapping of the continuous reference variable in the second preset data range. In an example, the continuous reference variable is a temperature reference variable, and the change range of the temperature of a place in the history time period changes is 10° C.˜30° C. That is, the data value corresponding to the temperature change should be 10˜30, and data normalization may be performed on the original data value of 10˜30 based on the second preset data range of 0˜1. Optionally, after the data normalization, the characteristic value in each dimension of the processed normalized continuous reference variable is also a normalized characteristic value.

In step 502, a characteristic matrix corresponding to the continuous reference variable is built based on the normalized continuous reference variable.

Optionally, all continuous reference variables in one history time period are selected to build a unique continuous characteristic matrix. Alternatively, at least one continuous reference variable in one history time period is selected as a representative of all the continuous reference variables to build a unique continuous characteristic matrix.

Optionally, building a characteristic matrix corresponding to the continuous reference variable based on the normalized continuous reference variable includes building of a continuous characteristic matrix based on the normalized characteristic values in all dimensions, or building of a discrete characteristic matrix based on the normalized characteristic values in some dimensions.

In an example, the continuous reference variables are temperature reference variables and power consumption reference variables. After normalizing the temperature reference variable and the power consumption reference variable according to a second variable range, and acquiring the characteristics of the temperature reference variable and the power consumption reference variable, a 16-dimensional characteristic of the temperature reference variable and a 16-dimensional characteristic of the power consumption reference variable are acquired and arranged in one column to acquire a 1-row 32-column characteristic matrix. By performing convolution kernel calculation on the characteristic matrix, the continuous variable characteristic corresponding to the characteristic matrix is acquired.

In step 503, a continuous variable characteristic corresponding to the continuous reference variable is determined based on the continuous characteristic matrix.

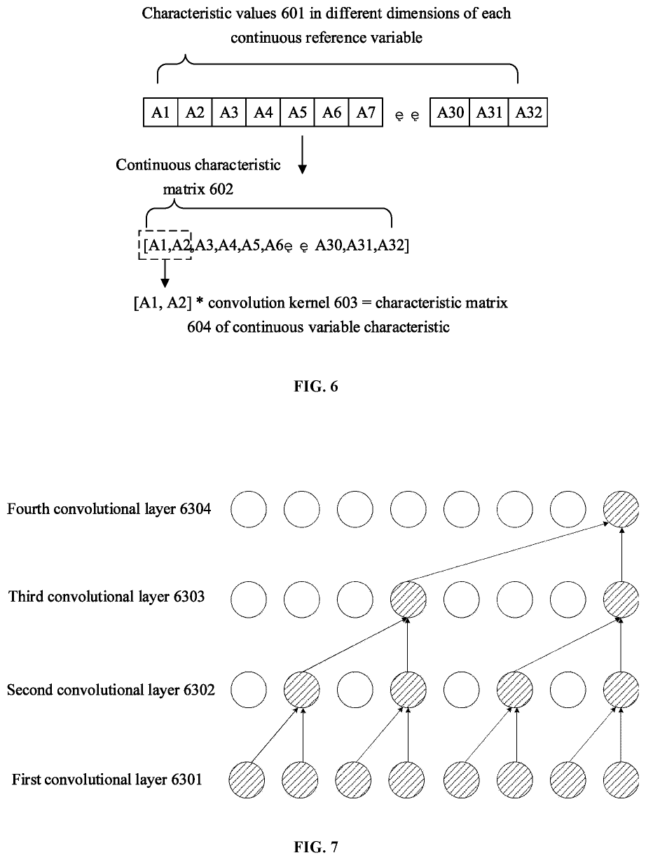

FIG. 6 is a schematic diagram of acquiring a continuous variable characteristic by convolution kernel calculation in accordance with an example embodiment of the present disclosure. Optionally, characteristic values 601 in different dimensions of each continuous reference variable are acquired, a 1-row 32-column continuous characteristic matrix 602 is generated by the characteristic values 601, and calculation results of convolution kernels of different sizes are acquired as the characteristic matrix 604 of the continuous variable characteristic by cross-multiplying calculation of the convolution kernel 603 and at least one item of the continuous characteristic matrix 602. Referring to FIG. 6, a characteristic matrix 604 that represents continuous variable characteristics of a characteristic value A1 and a characteristic value A2 in the continuous characteristic matrix 602 is acquired by cross-multiplying calculation of the convolution kernel 603 and the first two items in the continuous characteristic matrix 602. Optionally, the convolution kernel 603 is a 1-column matrix. The number of items in the characteristic matrix of the continuous variable characteristic can be controlled by the number of items in the continuous characteristic matrix 602 for calculation with the convolution kernel. When the convolution kernel and all items in the continuous characteristic matrix are calculated, the continuous variable characteristic corresponding to the continuous reference variable can be determined.

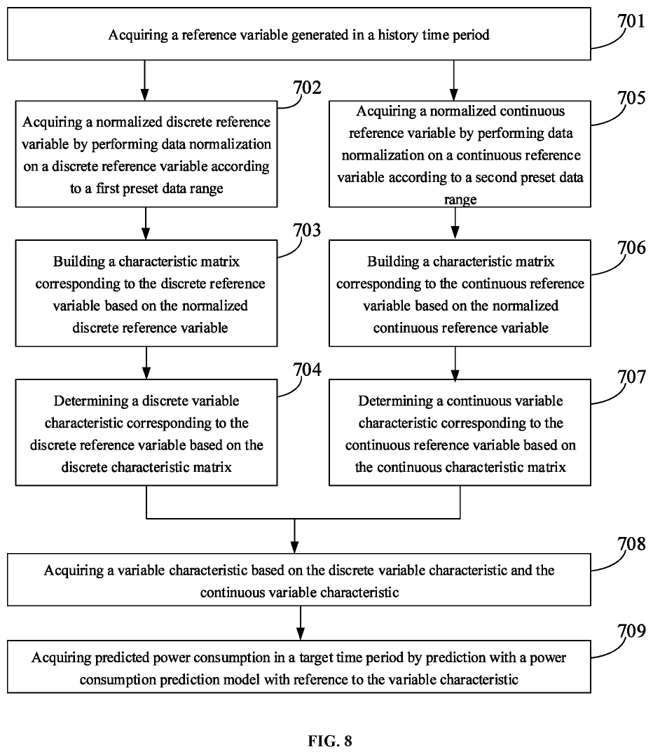

Optionally, training is performed by cross-multiplying the convolution kernel 603 and a characteristic vector composed of at least one item in the continuous characteristic matrix 602. FIG. 7 is a schematic diagram showing training of a convolution kernel in accordance with an example embodiment of the present disclosure. Referring to FIG. 7, one convolution kernel in a first convolutional layer 6301 can only represent a characteristic vector of two adjacent items, i.e., in the first convolutional layer, the size of the convolution kernel is two items, and the size of the convolution kernel trained by a second convolutional layer 6302 becomes 4 items. Further, a final convolution kernel trained by a third convolutional layer 6303 and a fourth convolutional layer 6304 can represent the characteristics of the entire characteristic matrix, and the final continuous variable characteristic can be acquired through the convolution kernel.

In summary, according to the method provided by the present embodiment, by normalizing the continuous reference variable, building the continuous characteristic matrix, and training the convolution kernel and the continuous characteristic matrix, the continuous variable characteristics corresponding to all the continuous reference variables are acquired finally. The processed continuous variable characteristic is input into the power consumption prediction model. Thus, the accuracy in predicting the power consumption is improved.

FIG. 8 is flow diagram of a method for predicting power consumption in accordance with an example embodiment of the present disclosure. By taking that the method is applied to a server as an example for explanation, the method includes the following steps.

In step 701, a reference variable generated in a history time period is acquired.

Optionally, the number of the history time periods is at least one. Optionally, the server acquires the same reference variable when acquiring a reference variable in each history time period.

After the reference variable is acquired, whether the reference variable is a discrete reference variable or a continuous reference variable is determined, and steps 702 to 704 and steps 705 to 707 are performed at the same time.

In step 702, data normalization is performed on a discrete reference variable according to a first preset data range to obtain a normalized discrete reference variable.

Optionally, after the discrete reference variable is acquired, the discrete reference variable is normalized according to the first preset data range, so that the acquired normalized discrete reference variable and a characteristic value extracted therefrom are within the first preset data range.

In step 703, a characteristic matrix corresponding to the discrete reference variable is built based on the normalized discrete reference variable.

Optionally, the characteristic matrix corresponding to the discrete reference variable is built by the method for building the characteristic matrix in step 302.

In step 704, a discrete variable characteristic corresponding to the discrete reference variable is determined based on the discrete characteristic matrix.

Optionally, the discrete variable characteristic corresponding to the discrete reference variable is determined by the method for determining the discrete variable characteristic in step 303.

In step 705, data normalization is performed on a continuous reference variable according to a second preset data range to obtain a normalized continuous reference variable.

In step 706, a characteristic matrix corresponding to the continuous reference variable is built based on the normalized continuous reference variable.

In step 707, a continuous variable characteristic corresponding to the continuous reference variable is determined according to the continuous characteristic matrix.

Optionally, steps 705 to 707 correspond to steps 501 to 503, and the continuous variable characteristic corresponding to the continuous reference variable is determined by the method in the detailed embodiment of steps 501 to 503.

Optionally, the method for extracting characteristics e described in steps 702 to 707 is the same as the method for acquiring the variable characteristics described in the following step 708, which is completed in a power consumption prediction model.

In step 708, variable characteristics are acquired based on the discrete variable characteristic and the continuous variable characteristic.

Optionally, the numerical value of the variable characteristic is calculated by weighted summation on each variable characteristic. Optionally, acquisition of variable characteristics based on variable characteristics may be completed in the power consumption prediction model, that is, multiple variable characteristics corresponding to one history time period are all input into the power consumption prediction model, and weighted summation is performed on these variable characteristics in the power consumption prediction model to acquire the variable characteristics.

In step 709, prediction is performed with a power consumption prediction model with reference to the variable characteristic to acquire predicted power consumption in a target time period.

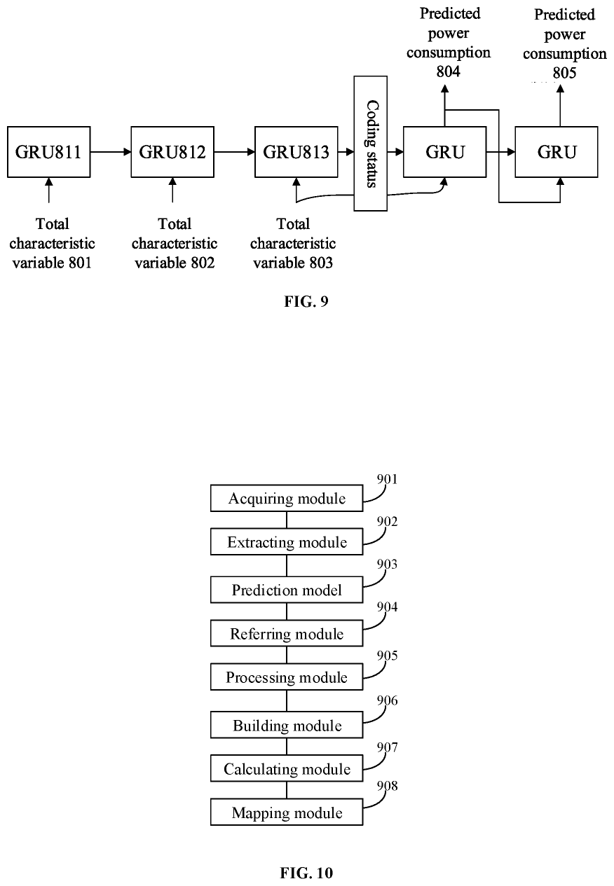

FIG. 9 is a schematic diagram of acquiring predicted power consumption in a target time period by inputting variable characteristics into a power consumption prediction model in accordance with an example embodiment of the present disclosure. Referring to FIG. 8, in this example, three different variable characteristics, namely, a variable characteristic 801, a variable characteristic 802 and a variable characteristic 803, are generated based on three different history time periods and input into a GRU 811, a GRU 812 and a GRU 813 of a trained power consumption prediction model, and the predicted power consumption 804 corresponding to the target time period is acquired by encoding and decoding. After the predicted power consumption 804 corresponding to the target time period is acquired, predicted power consumption 805 in the next target time period may be acquired based on the predicted power consumption 804.

In summary, according to the method provided by the present embodiment, the reference variables, including the discrete reference variable and the continuous reference variable, in the history time period are acquired, characteristics of the acquired reference variables are extracted, and the extracted variable characteristics are input into a variable prediction model, to output the predicted power consumption in the target time period. During prediction of power consumption, the power consumption in the target time period is predicted from different perspectives based on various parameters, so that the accuracy in predicting the power consumption is improved.

By normalizing the discrete reference variables, building the discrete characteristic matrix, and processing the discrete characteristic matrix by the characteristic acquiring matrix, to finally acquire the discrete variable characteristics, the characteristic matrix is independently generated for each result of each discrete reference variable and processed to obtain the corresponding discrete variable characteristic. The processed discrete variable characteristics are input into the power consumption prediction model, to improve the accuracy in predicting the power consumption.

By normalizing the continuous reference variable, building the continuous characteristic matrix, and training the convolution kernel and the continuous characteristic matrix to finally acquire the continuous variable characteristics corresponding to all the continuous reference variables. The processed continuous variable characteristics are input into the power consumption prediction model, to improve the accuracy in predicting the power consumption.

By processing the discrete variable characteristics and the continuous variable characteristics, the variable characteristics that can reflect the characteristics of the history time period are acquired, so that the value input into the power consumption prediction model can represent the characteristics of the history time period more comprehensively. Thus, the accuracy in predicting the power consumption is improved.

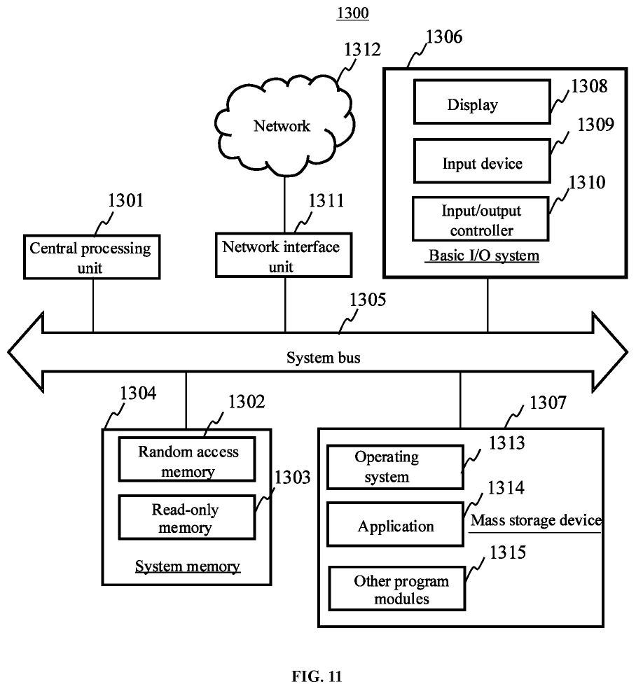

FIG. 10 is a structural block diagram of an apparatus for predicting power consumption in accordance with an example embodiment of the present disclosure. The apparatus includes:

an acquiring module 901, configured to acquire a reference variable generated in a history time period, the reference variable including a discrete reference variable and a continuous reference variable, the discrete reference variable being a variable collected in the history time period according to a preset duration, and the continuous reference variable being a variable continuously collected in the history time period;

an extracting module 902, configured to extracting a characteristic of the reference variable with a power consumption prediction model to obtain a variable characteristic, the power consumption prediction model being obtained by training a sample reference variable marked with sample power consumption, the sample reference variable including a sample discrete variable and a sample continuous variable; and

a prediction model 903, configured to acquire predicted power consumption in a target time period by prediction with the power consumption prediction model based on the variable characteristic, the target time period and the history time period having a corresponding relationship.

In an optional embodiment, the extracting module is configured to extract characteristics of the discrete reference variable with the power consumption prediction model to acquire a discrete variable characteristic.

The extracting module 902 is configured to extract characteristics of the continuous reference variable with the power consumption prediction model to acquire a continuous variable characteristic.

The apparatus further includes a referring to module 904 configured to acquire the variable characteristic by referring to the discrete variable characteristic with the continuous variable characteristic.

In an optional embodiment, the apparatus further includes: a processing module 905 configured to perform data normalization on the discrete reference variable within a first preset data range with the power consumption prediction model to acquire a normalized discrete variable;

a building module 906 configured to build a discrete characteristic matrix based on the normalized discrete variable; and

a calculating module 907 configured to acquire the discrete variable characteristic corresponding to the discrete reference variable by calculation with reference to the discrete characteristic matrix.

In an optional embodiment, the apparatus further includes a mapping module 908 configured to map the discrete reference variable to be within the first preset data range with the power consumption prediction model to acquire the normalized discrete variable.

In an optional embodiment, the discrete reference variable includes at least one of a time reference variable, a season reference variable and a holiday reference variable;

the time reference variable includes a date corresponding to the history time period;

the season reference variable includes a season corresponding the history time period; and

the holiday reference variable includes nature of a holiday corresponding to the history time period.

In an optional embodiment, the processing module 905 is configured to perform data normalization on the continuous reference variable in a second preset data range with the power consumption prediction model to acquire a normalized continuous variable;

the building module 906 is configured to build a continuous characteristic matrix based on the normalized continuous variable; and

the calculating module 907 is configured to calculate the continuous characteristic matrix to acquire a continuous variable characteristic corresponding to the continuous reference variable.

In an optional embodiment, the mapping module 908 is configured to map the continuous reference variable to be within the second preset data range with the power consumption prediction model to obtain the normalized continuous variable.

In an optional embodiment, the continuous reference variable includes at least one of a temperature reference variable, a power consumption reference variable and a humidity reference variable;

the temperature reference variable indicates a temperature in the history time period;

the power consumption reference variable indicates total power consumption in the history time period; and

the humidity reference variable indicates air humidity in the history time period.

It should be noted that the apparatus for predicting power consumption provided by the above embodiment only takes division of all the functional modules as an example for explanation. In practice, the above functions may be assigned to be completed by different functional modules as required. That is, the internal structure of the apparatus is divided into different functional modules to complete all or part of the functions described above.

The present disclosure further provides a server. The server includes a processor and a memory storing at least one instruction. The at least one instruction, when loaded and executed by a processor, causes the processor to implement the methods for predicting power consumption provided in the foregoing method embodiments. It should be noted that the server may be a server provided in FIG. 11.

Referring to FIG. 11, it shows a schematic structural diagram of a server in accordance with an example embodiment of the present disclosure. Specifically, a server 1300 includes a Central Processing Unit (CPU) 1301, a system memory 1304 including a Random Access Memory (RAM) 1302 and a Read-Only Memory (ROM) 1303, and a system bus 1305 connecting the system memory 1304 and the CPU 1301. The server 1300 further includes a basic Input/Output (I/O) system 1306 which helps transmit information among various components in a computer, and a mass storage device 1307 configured to store an operating system 1313, an application 1314 and other program modules 1315.

The basic I/O system 1306 includes a display 1308 configured to display information and an input device 1309, such as a mouse or a keyboard, configured to input information by users. Both the display 1308 and the input device 1309 are connected to the CPU 1301 through an input/output controller 1310 connected to the system bus 1305. The basic I/O system 1306 may also include the input/output controller 1310 for receiving and processing input from a plurality of other devices, such as a keyboard, a mouse, or an electronic stylus. Similarly, the input/output controller 1310 further provides output to a display screen, a printer or other types of output devices.

The mass storage device 1307 is connected to the CPU 1301 through a mass storage controller (not shown) connected to the system bus 1305. The mass storage device 1307 and a computer-readable medium associated therewith provide non-volatile storage for the server 1300. That is, the mass storage device 1307 may include a computer-readable medium (not shown), such as a hard disk or a CD-ROM driver.

Without loss of generality, the computer-readable medium may include a computer storage medium and a communication medium. The computer storage medium includes volatile and non-volatile, removable and non-removable media implemented by any method or technology and configured to store information such as computer-readable instructions, data structures, program modules or other data. The computer storage medium includes an RAM, an ROM, an Erasable Programmable Read Only Memory (EPROM), an Electrically Erasable Programmable Read-Only Memory (EEPROM), a flash memory or other solid-status storage technologies; a CD-ROM, a Digital Video Disc (DVD) or other optical storage; and a tape cartridge, a magnetic tape, a disk storage or other magnetic storage devices. Of course, it will be known by a person skilled in the art that the computer storage medium is not limited to above. The above system memory 1304 and the mass storage device 1307 may be collectively referred to as memories.

The memory stores one or more programs. The one or more programs are configured to be executed by the one or more CPUs 1301. The one or more programs include instructions for implement the above methods for predicting power consumption. The CPU 1301 performs the one or more programs to implement the methods for predicting power consumption provided in the above method embodiments.

According to various embodiments of the present disclosure, the server 1300 may also be connected to a remote computer on a network through the network, such as the Internet, for operation. That is, the server 1300 may be connected to a network 1312 through a network interface unit 1311 connected to the system bus 1305, or may be connected to other types of networks or remote computer systems (not shown) through the network interface unit 1311.

The memory further includes one or more programs stored therein, and the one or more programs include the steps performed by the server in the methods for predicting power consumption provided in the embodiments of the present disclosure.

Those skilled in the art shall appreciate that all or part of the steps of the methods provided in the above embodiments may be completed by related hardware instructed by a program, and the program may be stored in a computer-readable storage medium, which may be the computer-readable storage medium included in the memory in the foregoing embodiment or a computer-readable storage medium that exists alone and is not assembled in a terminal. The computer-readable storage medium stores at least one instruction, at least one program, a code set or an instruction set, and the at least one instruction, the at least one program, the code set or instruction set is loaded and executed by a processor to implement the aforementioned methods for predicting power consumption.

Optionally, the computer-readable storage medium may include a Read-Only Memory (ROM), a Random Access Memory (RAM), Solid status Drives (SSD), an optical disk or the like. The RAM may include a Resistance Random Access Memory (ReRAM) and a Dynamic Random Access Memory (DRAM). The serial numbers of the embodiments of the present disclosure are merely for description, and do not represent the priority of the embodiments.

Persons of ordinary skill in the art can understand that all or part of the steps described in the above embodiments can be completed through hardware, or through relevant hardware instructed by a program that is stored in a computer-readable storage medium, such as a read-only memory, a disk, a CD or the like.

The foregoing descriptions are merely optional embodiments of the present disclosure, and are not intended to limit the present disclosure. Within the spirit and principles of the present disclosure, any modifications, equivalent substitutions, improvements, etc., should be within the protection scope of the present disclosure.

1. A method for predicting power consumption, comprising:
acquiring a reference variable generated by an electric device in a history time period, the reference variable comprising a discrete reference variable and a continuous reference variable, the discrete reference variable being collected according to a preset duration in the history time period, and the continuous reference variable being continuously collected in the history time period;
acquiring a variable characteristic by extracting a characteristic of the reference variable with a power consumption prediction model, wherein the power consumption prediction model is obtained by training a sample reference variable marked with sample power consumption, the sample reference variable comprising a sample discrete variable and a sample continuous variable; and
acquiring predicted power consumption in a target time period by prediction with the power consumption prediction model based on the variable characteristic, the target time period and the history time period having a corresponding relationship.

2. The method according to claim 1, wherein acquiring the variable characteristic by extracting the characteristic of the reference variable comprises:
acquiring a discrete variable characteristic by extracting a characteristic of the discrete reference variable with the power consumption prediction model;
acquiring a continuous variable characteristic by extracting a characteristic of the continuous reference variable with the power consumption prediction model; and
acquiring the variable characteristic by referring to the discrete variable characteristic with the continuous variable characteristic.

3. The method according to claim 2, wherein acquiring the discrete variable characteristic by extracting the characteristic of the discrete reference variable with the power consumption prediction model comprises:
acquiring a normalized discrete variable by performing data normalization on the discrete reference variable within a first preset data range with the power consumption prediction model;
building a discrete characteristic matrix corresponding to the normalized discrete variable; and
acquiring the discrete variable characteristic corresponding to the discrete reference variable by calculation by referring to the discrete characteristic matrix.

4. The method according to claim 3, wherein acquiring the normalized discrete variable by performing data normalization on the discrete reference variable within the first preset data range with the power consumption prediction model comprises:
acquiring the normalized discrete variable by mapping the discrete reference variable to the first preset data range with the power consumption prediction model.

5. The method according to claim 3, wherein the discrete reference variable comprises at least one of a time reference variable, a season reference variable and a holiday reference variable;
the time reference variable comprises a date corresponding to the history time period;
the season reference variable comprises a season corresponding to the history time period; and
the holiday reference variable comprises nature of a holiday corresponding to the history time period.

6. The method according to claim 2, wherein acquiring the continuous variable characteristic by extracting the characteristic of the continuous reference variable with the power consumption prediction model comprises:
acquiring a normalized continuous variable by performing data normalization on the continuous reference variable in a second preset data range with the power consumption prediction model;
building a continuous characteristic matrix based on the normalized continuous variable; and
acquiring the continuous variable characteristic corresponding to the continuous reference variable by calculating the continuous characteristic matrix.

7. The method according to claim 6, wherein acquiring the normalized continuous variable by performing data normalization on the continuous reference variable in the second preset data range with the power consumption prediction model comprises:
acquiring the normalized continuous variable by mapping the continuous reference variable to the second preset data range with the power consumption prediction model.

8. The method according to claim 6, wherein the continuous reference variable comprises at least one of a temperature reference variable, a power consumption reference variable and a humidity reference variable;
the temperature reference variable indicates temperature in the history time period;
the power consumption reference variable indicates total power consumption in the history time period; and
the humidity reference variable indicates air humidity in the history time period.

9. An apparatus for predicting power consumption, comprising:
an acquiring module, configured to acquire a reference variable generated in a history time period, the reference variable comprising a discrete reference variable and a continuous reference variable, the discrete reference variable being collected according to a preset duration in the history time period, and the continuous reference variable being continuously collected in the history time period;
an extracting module, configured to acquire a variable characteristic by extracting a characteristic of the reference variable with a power consumption prediction model, wherein the power consumption prediction model is obtained by training a sample reference variable marked with sample power consumption, the sample reference variable comprising a sample discrete variable and a sample continuous variable; and
a predicting module, configured to acquire predicted power consumption in a target time period by prediction with the power consumption prediction model based on the variable characteristic, the target time period and the history time period having a corresponding relationship.

10. A computer device, comprising:
a processor; and
a memory storing at least one instruction, at least one program, at least one code set, or at least one instruction set therein, wherein the at least one instruction, the at least one program, the at least one code set, or the at least one instruction set, when loaded and executed by the processor, causes the processor to implement a method for predicting power consumption according to comprising:
acquiring a reference variable generated by an electric device in a history time period, the reference variable comprising a discrete reference variable and a continuous reference variable, the discrete reference variable being collected according to a preset duration in the history time period, and the continuous reference variable being continuously collected in the history time period;
acquiring a variable characteristic by extracting a characteristic of the reference variable with a power consumption prediction model, wherein the power consumption prediction model is obtained by training a sample reference variable marked with sample power consumption, the sample reference variable comprising a sample discrete variable and a sample continuous variable; and
acquiring predicted power consumption in a target time period by prediction with the power consumption prediction model based on the variable characteristic, the target time period and the history time period having a corresponding relationship.

11. A computer-readable storage medium storing at least one instruction, at least one program, at least one code set, or at least one instruction set therein, wherein the at least one instruction, the at least one program, the at least one code set, or the at least one instruction set, when loaded and executed by a processor, causes the processor to implement a method for predicting power consumption comprising:
acquiring a reference variable generated by an electric device in a history time period, the reference variable comprising a discrete reference variable and a continuous reference variable, the discrete reference variable being collected according to a preset duration in the history time period, and the continuous reference variable being continuously collected in the history time period;
acquiring a variable characteristic by extracting a characteristic of the reference variable with a power consumption prediction model, wherein the power consumption prediction model is obtained by training a sample reference variable marked with sample power consumption, the sample reference variable comprising a sample discrete variable and a sample continuous variable; and
acquiring predicted power consumption in a target time period by prediction with the power consumption prediction model based on the variable characteristic, the target time period and the history time period having a corresponding relationship.
